(19) United States
(12) Patent Application Publication
(10) Pub. No.: US 2024/0185099 A1
(43) Pub. Date: Jun. 6, 2024

(54) USER RESPONSE COLLECTION INTERFACE GENERATION AND MANAGEMENT USING MACHINE LEARNING TECHNOLOGIES

(71) Applicant: Spherex, Inc., Santa Clara, CA (US)

(72) Inventors: Teresa Ann Phillips, Los Altos, CA (US); Pranav Anand Joshi, Cerritos, CA (US); Kira Michelle McStay, Los Angeles, CA (US)

(21) Appl. No.: 18/073,386

(22) Filed: Dec. 1, 2022

(51) Int. Cl. G06N 5/04

(52) U.S. Cl. CPC G06N 5/04

(57) ABSTRACT

Various embodiments described herein support or provide generation and management operations of user response collection interfaces using machine learning technologies, including receiving a user input from a user interface of a device, the user input including data content that describes context of a media asset; using a machine learning model to generate analysis of the context of the media asset based on the data content; dynamically generating a question based on the analysis of the context of the media asset; and causing display of the question and the plurality of answers on the user interface of the device.

### TECHNICAL FIELD

The present disclosure generally relates to data management, and, more particularly, various embodiments described herein provide for systems, methods, techniques, instruction sequences, and devices that facilitate the generation and management of user response collection interfaces using machine learning technologies.

### BACKGROUND

Current systems face challenges when it comes to providing a thorough analysis of the content of media assets with a deep understanding of the cultures and complexities of the global regulatory environment, as well as a vision for how to engineer and train machine learning and artificial intelligence systems properly. Specifically, the current systems face challenges to dynamically generate questions and answer choices that are most relevant and likely to elicit feedback that helps aid the analysis of the content of media assets in the most efficient way.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of examples, and not limitations, in the accompanying figures.

FIG. 1 is a block diagram showing an example data system that includes a data management system in an artificial intelligence system, according to various embodiments of the present disclosure.

FIG. 2 is a block diagram illustrating an example data management system for generating and managing user response collection interfaces using machine learning technologies, according to various embodiments of the present disclosure.

FIG. 3 is a flowchart illustrating an example method for generating and managing user response collection interfaces using machine learning technologies via an example data management system during operation, according to various embodiments of the present disclosure.

FIG. 4 is a flowchart illustrating an example method for generating and managing user response collection interfaces using machine learning technologies, according to various embodiments of the present disclosure.

FIG. 5 is a flowchart illustrating an example method for generating and managing user response collection interfaces using machine learning technologies, according to various embodiments of the present disclosure.

FIG. 6 is a flowchart illustrating an example method for generating and managing user response collection interfaces using machine learning technologies, according to various embodiments of the present disclosure.

FIG. 7 illustrates an example graphical user interface caused to be displayed by an example data management system during operation, according to various embodiments of the present disclosure. As shown,

FIG. 8 illustrates an example graphical user interface caused to be displayed by an example data management system during operation, according to various embodiments of the present disclosure.

FIG. 9 illustrates an example graphical user interface caused to be displayed by an example data management system during operation, according to various embodiments of the present disclosure.

FIG. 10 is a block diagram illustrating a representative software architecture, which may be used in conjunction with various hardware architectures herein described, according to various embodiments of the present disclosure.

FIG. 11 is a block diagram illustrating components of a machine able to read instructions from a machine storage medium and perform any one or more of the methodologies discussed herein according to various embodiments of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of embodiments. It will be evident, however, to one skilled in the art that the present inventive subject matter can be practiced without these specific details.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described can be practiced without the specific details presented herein, or in various combinations, as described herein. Furthermore, well-known features can be omitted or simplified in order not to obscure the described embodiments. Various embodiments may be given throughout this description. These are merely descriptions of specific embodiments. The scope or meaning of the claims is not limited to the embodiments given.

Various embodiments described herein can use state-of-the-art machine-learning and artificial intelligence technologies to analyze and process millions of hours of media assets and the associated metadata effectively. As used herein, a machine learning model can comprise any predictive model that is generated based on (or that is trained on) training data. Once generated/trained, a machine learning model can receive one or more inputs (e.g., one or more tags), extract one or more features, and generate an output for the inputs based on the model's training. Different types of machine learning models can include, without limitation, ones trained using supervised learning, unsupervised learning, reinforcement learning, or deep learning (e.g., complex neural networks).

Various embodiments include systems, methods, and non-transitory computer-readable media that facilitate the generation and management of user response collection interfaces using machine learning (ML) technologies and artificial intelligence (AI) technologies.

In various embodiments, a data management system receives one or more user inputs from a user interface of a device. The one or more user inputs include data content that describes the context of one or more media assets. The data management system uses one or more machine learning models to generate the analysis of the context of the one or more media assets based on the data content.

In various embodiments, a data management system dynamically generates a question based on the analysis of the context of a media asset. A plurality of answers (e.g., selectable answer choices) associated with the question may also be dynamically generated. The data management system causes the display of the question and the plurality of answers on the user interface of the device.

In various embodiments, the one or more machine learning models may include models that are built and/or trained based on natural language processing, such as prompt engineering technology.

In various embodiments, the data management system may use prompt engineering technology to generate the analysis of the context of the media asset. Specifically, the data management system generates a task description based on the context of the media asset. Based on the task description and a taxonomy associated with a geographical location of the media asset, the data management system identifies an example question and a set of example answers. The geographical location of the media asset may be determined (or identified) based on the context of the media asset or user input. The data management system generates a prompt input that includes the task description, the example question, and the set of example answers. The data management system uses the one or more machine learning models to dynamically generate the question and the plurality of answers based on the prompt input.

In various embodiments, the one or more machine learning models are pre-trained on training data (e.g., a high volume of training data, such as raw texts). A prompting function may be learned (or defined) to perform few-shot or zero-shot learning. In various embodiments, the one or more machine learning models are Natural language processing (NLP) machine learning models.

In various embodiments, the data management system dynamically selects (or pre-selects) one or more recommended answers from the plurality of answers based on the analysis of the context of the media asset. The dynamic selection of the recommended answers may be based on the analysis of the context of the media asset.

Specifically, the data management system determines one or more geographical locations associated with the media asset based on the data content or user input. The data management system determines a taxonomy based on the geographical location. The taxonomy may be a pre-determined cultural attributes classification ontology/taxonomy. For example, a cultural attributes classification taxonomy of the United States may comprise a different set of cultural attributes than a taxonomy that is customized for Japan. A geographical region may refer to a country or a region within a country. A taxonomy, such as a cultural attributes classification ontology/taxonomy, may be generated by a multi-modal architecture that is communicatively coupled to the data management system described herein, or by a third-party system.

In various embodiments, the data management system uses the one or more machine learning models to dynamically select the one or more recommended answers based on the taxonomy and the context of the media asset.

In various embodiments, the data management system receives from the user interface a selection of an answer from the plurality of answers. The data management system updates the context of the media asset based on the selection of the answer and generates another task description (e.g., a second task description) based on the updated context of the media asset. The data management system identifies another example question (e.g., a second example question) and another set of example answers (e.g., a second set of example answers) based on the second task description and the determined taxonomy (e.g., cultural attributes classification ontology or taxonomy) associated with the geographical location of the media asset.

In various embodiments, the data management system generates another prompt input (e.g., a second prompt input) that includes the second task description, the second example question, and the second set of example answers, as described herein. The data management system uses the one or more machine learning models to dynamically generate another question (e.g., a second question) and another plurality of answers (e.g., a second plurality of answers) based on the second prompt input. In various embodiments, the data management system causes the display of the second question and the second plurality of answers in the user interface of the device.

Upon detecting that the user selects answers to the second plurality of answers, the data management system can further update the context of the media asset and generates an analysis of the updated context using the one or more machine learning models described herein. Specifically, the data management system receives a selection of an answer from the plurality of answers and determines further context (e.g., a second context of the media asset) based on the selection of the answer. The data management system dynamically generates a further question (e.g., a second question) based on an analysis of the second context of the media asset. The second question is associated with the second plurality of answers.

In various embodiments, the data management system receives a media asset from a device and generates a user interface that includes a user response collection interface. A user response collection interface (e.g., questionnaire, survey) may include one or more questions and one or more associated answers (e.g., selectable answer choices), as described herein. The data management system causes the display of the user response collection interface in a user interface on the device for receiving the user inputs. As described herein, the content of the user response collection interface can be dynamically adjusted based on user inputs as the system continues learning the context of the media asset using the one or more machine learning models described herein. For example, a user response collection interface can be configured to initially include a default set of questions and selectable answers. The data management system continuously updates the context of the media asset based on selected answers, based on which more tailored (or relevant) questions and selectable answer choices may be generated. Under this approach, the data management system can reduce the number of questions (thereby reducing cognitive load for users) in a given questionnaire while learning and analyzing the context of the media asset in the most efficient way.

In various embodiments, A user interface or a graphical user interface, as described herein, may refer to human-computer interaction and communication on a device, displayed on a display screen of a device. A user response collection interface may refer to a collection of questions and answer choices that a user can select from through a user interface (e.g., graphical user interface) to elicit user responses or user feedback for media context and/or media content analysis described herein. A user interface may display or cause to be displayed an entire content (e.g., a collection of questions and answer choices) of a user response collection interface or a portion of the content of the user response collection interface at a time.

In various embodiments, a user response collection interface can include one or more questionnaires or surveys.

Reference will now be made in detail to embodiments of the present disclosure, examples of which are illustrated in the appended drawings. The present disclosure may, however, be embodied in many different forms and should not be construed as being limited to the embodiments set forth herein.

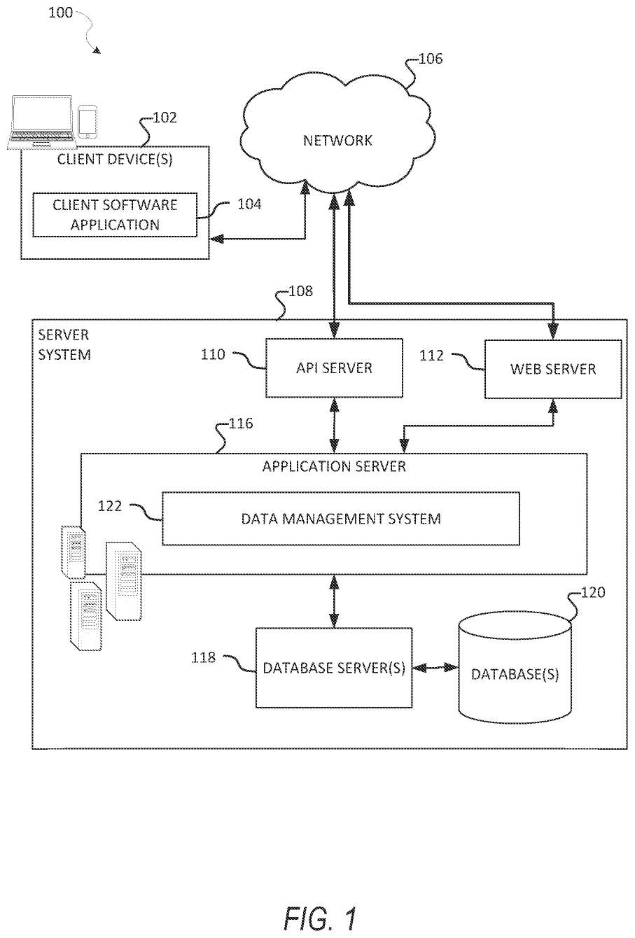

FIG. 1 is a block diagram showing an example data system 100 that includes a data management system (hereafter, the data management system 122, or system 122), according to various embodiments of the present disclosure. By including the data management system 122, the data system 100 (e.g., the multi-modal artificial intelligence (AI) system) can facilitate the generation and management of user response collection interfaces using machine learning technologies. As shown, the data system 100 includes one or more client devices 102, a server system 108, and a network 106 (e.g., including Internet, wide-area-network (WAN), local-area-network (LAN), wireless network, etc.) that communicatively couples them together. Each client device 102 can host a number of applications, including a client software application 104. The client software application 104 can communicate data with the server system 108 via a network 106. Accordingly, the client software application 104 can communicate and exchange data with the server system 108 via network 106.

The server system 108 provides server-side functionality via the network 106 to the client software application 104. While certain functions of the data system 100 are described herein as being performed by the data management system 122 on the server system 108, it will be appreciated that the location of certain functionality within the server system 108 is a design choice. For example, it may be technically preferable to initially deploy certain technology and functionality within the server system 108, but to later migrate this technology and functionality to the client software application 104.

The server system 108 supports various services and operations that are provided to the client software application 104 by the data management system 122. Such operations include transmitting data from the data management system 122 to the client software application 104, receiving data from the client software application 104 to the system 122, and the system 122 processing data generated by the client software application 104. Data exchanges within the data system 100 may be invoked and controlled through operations of software component environments available via one or more endpoints, or functions available via one or more user interfaces of the client software application 104, which may include web-based user interfaces provided by the server system 108 for presentation at the client device 102.

With respect to the server system 108, each of an Application Program Interface (API) server 110 and a web server 112 is coupled to an application server 116, which hosts the data management system 122. The application server 116 is communicatively coupled to a database server 118, which facilitates access to a database 120 that stores data associated with the application server 116, including data that may be generated or used by the data management system 122.

The API server 110 receives and transmits data (e.g., API calls, commands, requests, responses, and authentication data) between the client device 102 and the application server 116. Specifically, the API server 110 provides a set of interfaces (e.g., routines and protocols) that can be called or queried by the client software application 104 in order to invoke the functionality of the application server 116. The API server 110 exposes various functions supported by the application server 116 including, without limitation: user registration; login functionality; data object operations (e.g., generating, storing, retrieving, encrypting, decrypting, transferring, access rights, licensing, etc.); and user communications.

Through one or more web-based interfaces (e.g., web-based user interfaces), the web server 112 can support various functionality of the data management system 122 of the application server 116.

The application server 116 hosts a number of applications and subsystems, including the data management system 122, which supports various functions and services with respect to various embodiments described herein. The application server 116 is communicatively coupled to a database server 118, which facilitates access to database(s) 120 that stores data associated with the data management system 122.

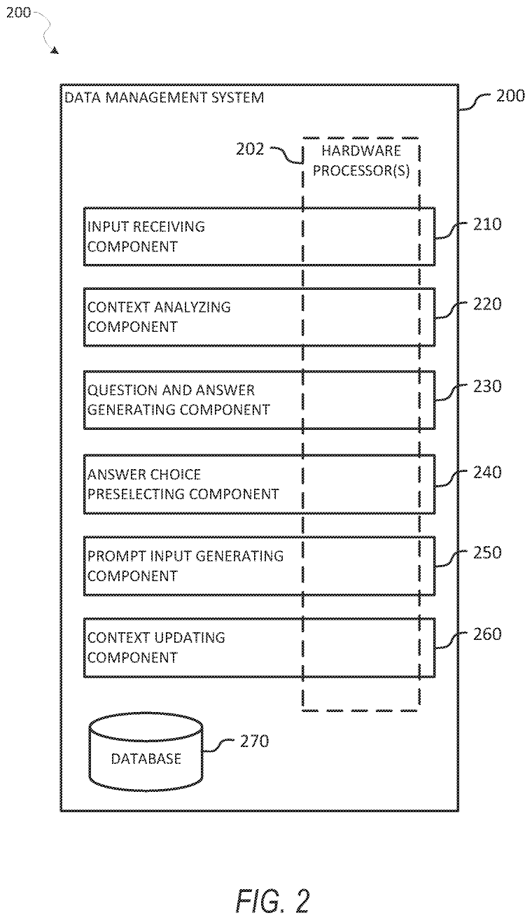

FIG. 2 is a block diagram illustrating an example data management system 200 for generating and managing user response collection interfaces using machine learning technologies, according to various embodiments of the present disclosure. For some embodiments, the data management system 200 represents an example of the data management system 122 described with respect to FIG. 1. As shown, the data management system 200 comprises an input receiving component 210, a context analyzing component 220, a question and answer generating component 230, an answer choice pre-selecting component 240, a prompt input generating component 250, and a context updating component 260. According to various embodiments, one or more of the input receiving component 210, the context analyzing component 220, the question and answer generating component 230, the answer choice pre-selecting component 240, the prompt input generating component 250, and the context updating component 260 are implemented by one or more hardware processors 202. Data generated by one or more of the input receiving component 210, the context analyzing component 220, the question and answer generating component 230, the answer choice pre-selecting component 240, the prompt input generating component 250, and the context updating component 260 may be stored in a database (or datastore) 270 of the data management system 200.

The input receiving component 210 is configured to receive one or more user inputs from a user interface of a device. The one or more user inputs include data content that describes the context of one or more media assets.

The context analyzing component 220 is configured to use one or more machine learning models to generate the analysis of the context of the one or more media assets based on the data content. In various embodiments, the context analyzing component 220 is configured to generate the analysis of the context of the one or more media assets based on one or more taxonomies associated with one or more geographical locations of the one or more media assets.

The question and answer generating component 230 is configured to dynamically generate questions based on the analysis of the context of a media asset. A plurality of answers (e.g., selectable answer choices) associated with the questions may also be dynamically generated.

The answer choice pre-selecting component 240 is configured to dynamically select (or pre-select) one or more recommended answers from the plurality of answers based on the analysis of the context of the media asset. The analysis of the context of the media asset includes an analysis of one or more taxonomies based on the geographical location of the media asset.

The prompt input generating component 250 is configured to generate one or more prompt inputs that include one or more task descriptions, example questions, and example answers. Based on the one or more prompt inputs, the one or more machine learning models can dynamically generate the questions and the plurality of answers, as described herein. The one or more task descriptions may be updated based on the updated context of media assets.

The context updating component 260 is configured to update the context of a media asset based on the selection of the answers. Based on the updated context, question and answer generating component 230 can generate an analysis of the updated context using the one or more machine learning models described herein.

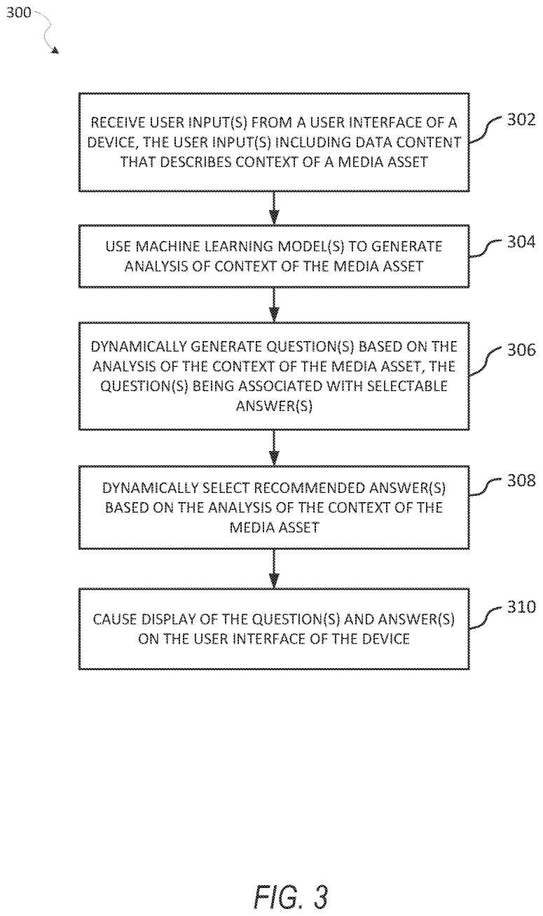

FIG. 3 is a flowchart illustrating an example method 300 for generating and managing user response collection interfaces using machine learning technologies, according to various embodiments of the present disclosure. It will be understood that example methods described herein may be performed by a machine in accordance with some embodiments. For example, method 300 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 300 may be represented by executable instructions that, when executed by a processor of a computing device, cause the computing device to perform method 300. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

At operation 302, a processor receives one or more user inputs from a user interface of a device. The one or more user inputs include data content that describes the context of one or more media assets.

At operation 304, a processor uses one or more machine learning models to generate the analysis of the context of the one or more media assets based on the data content. As used herein, a machine learning model can comprise any predictive model that is generated based on (or that is trained on) training data. Once generated/trained, a machine learning model can receive one or more inputs (e.g., prompt inputs), extract one or more features, and generate an output (e.g., questions and selectable answer choices) for the inputs based on the model's training.

At operation 306, a processor dynamically generates questions based on the analysis of the context of a media asset. A plurality of answers (e.g., selectable answer choices) associated with the questions may also be dynamically generated.

At operation 308, a processor dynamically selects (or pre-selects) one or more recommended answers from the plurality of answers based on the analysis of the context of the media asset, including the analysis of one or more taxonomies based on the geographical location of the media asset.

At operation 310, a processor causes the display of the questions and the plurality of answers, including the one or more recommended answers on a user interface of the device.

Though not illustrated, method 300 can include an operation where a graphical user interface can be displayed (or caused to be displayed) by the hardware processor. For instance, the operation can cause a client device (e.g., the client device 102 communicatively coupled to the data management system 122) to display the graphical user interface for generating and managing one or more user response collection interfaces. This operation for displaying the graphical user interface can be separate from operations 302 through 310 or, alternatively, form part of one or more of operations 302 through 310.

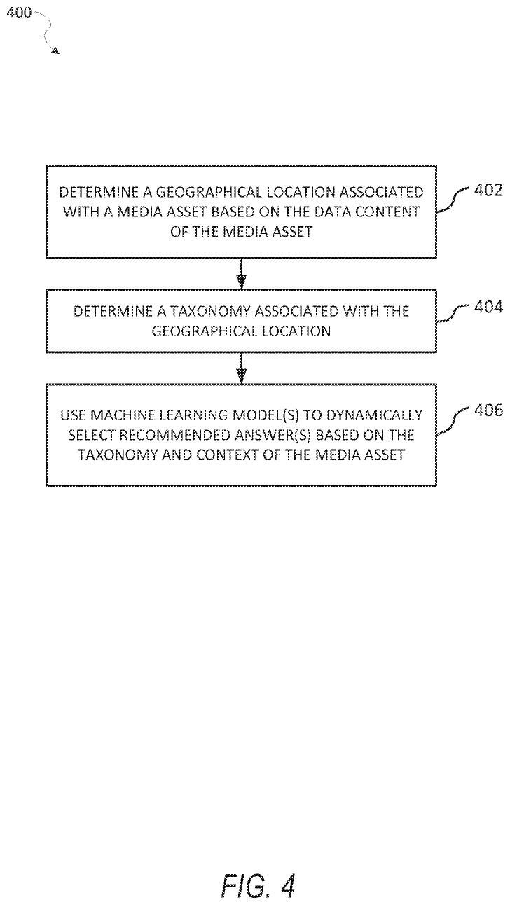

FIG. 4 is a flowchart illustrating an example method 400 for generating and managing user response collection interfaces using machine learning technologies, according to various embodiments of the present disclosure. It will be understood that example methods described herein may be performed by a machine in accordance with some embodiments. For example, method 400 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 400 may be represented by executable instructions that, when executed by a processor of a computing device, cause the computing device to perform method 400. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

At operation 402, the processor determines one or more geographical locations associated with the media asset based on the data content or user input.

At operation 404, the processor determines a taxonomy based on the geographical location. The taxonomy may be a pre-determined cultural attributes classification ontology/taxonomy. For example, a cultural attributes classification taxonomy of the United States may comprise a different set of cultural attributes than a taxonomy that is customized for Japan. A geographical region may refer to a country or a region within a country. A taxonomy, such as a cultural attributes classification ontology/taxonomy, may be generated by a multi-modal architecture that is communicatively coupled to the data management system described herein, or by a third-party system.

At operation 406, the processor uses the one or more machine learning models to dynamically select the one or more recommended answers based on the taxonomy and the context and/or content of the media asset.

Though not illustrated, method 400 can include an operation where a graphical user interface can be displayed (or caused to be displayed) by the hardware processor. For instance, the operation can cause a client device (e.g., the client device 102 communicatively coupled to the data management system 122) to display the graphical user interface for generating and managing one or more user response collection interfaces. This operation for displaying the graphical user interface can be separate from operations 402 through 406 or, alternatively, form part of one or more of operations 402 through 406.

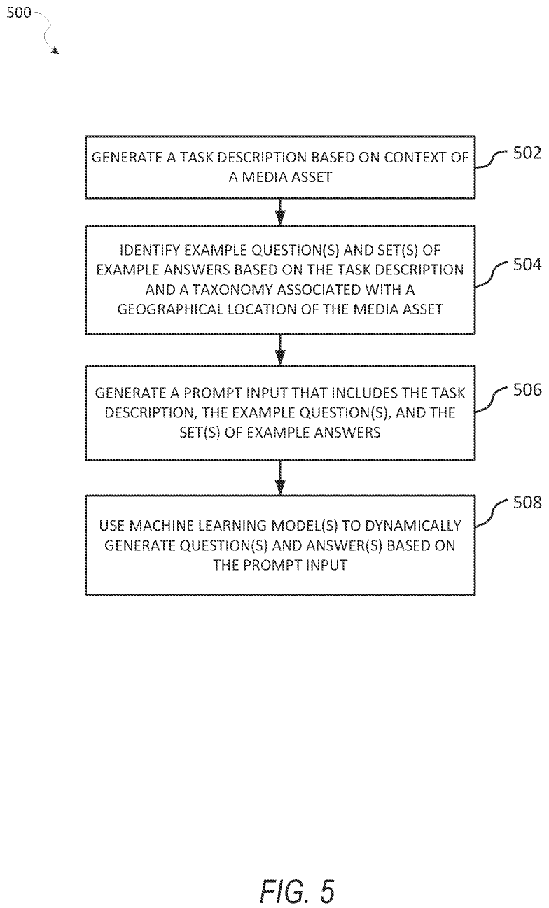

FIG. 5 is a flowchart illustrating an example method 400 for generating and managing user response collection interfaces using machine learning technologies, according to various embodiments of the present disclosure. It will be understood that example methods described herein may be performed by a machine in accordance with some embodiments. For example, method 500 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 500 may be represented by executable instructions that, when executed by a processor of a computing device, cause the computing device to perform method 500. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

At operation 502, the processor generates a task description based on the context of the media asset. A task description describes the purpose of the specific task. An example task description can be “generating a question to clarify a type of drug use,” or “generating all possible answers to a question that makes an inquiry about the distribution region of a media asset.”

At operation 504, the processor identifies an example question and a set of example answers based on the task description and a taxonomy associated with a geographical location of the media asset. The geographical location of the media asset may be determined (or identified) based on the context of the media asset or user input.

At operation 506, the processor generates a prompt input that includes the task description, the example question, and the set of example answers. The prompt input serves as an input to a machine learning model (e.g., a pre-trained language ML model).

At operation 508, the processor uses the one or more machine learning models (e.g., pre-trained language ML models) to dynamically generate the question and the plurality of answers based on the prompt input.

Though not illustrated, method 500 can include an operation where a graphical user interface can be displayed (or caused to be displayed) by the hardware processor. For instance, the operation can cause a client device (e.g., the client device 102 communicatively coupled to the data management system 122) to display the graphical user interface for generating and managing one or more user response collection interfaces. This operation for displaying the graphical user interface can be separate from operations 502 through 510 or, alternatively, form part of one or more of operations 502 through 510.

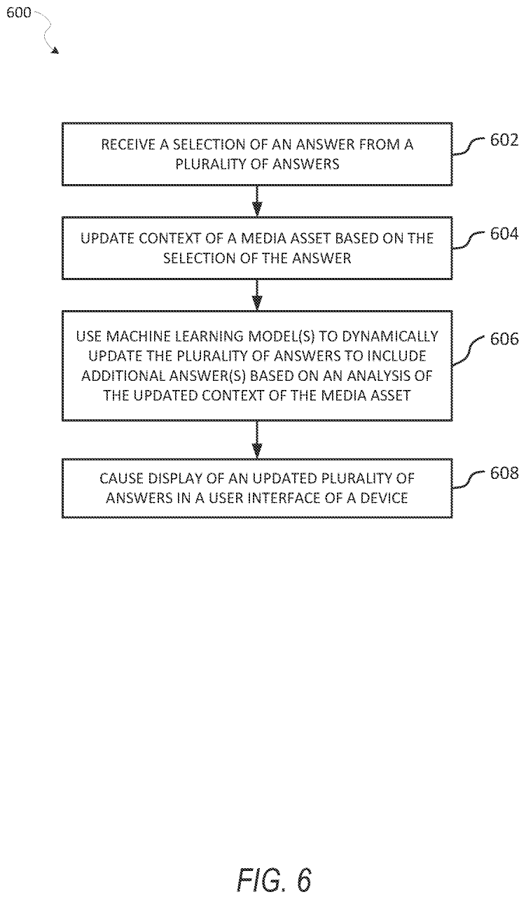

FIG. 6 is a flowchart illustrating an example method 600 for generating and managing user response collection interfaces using machine learning technologies, according to various embodiments of the present disclosure. It will be understood that example methods described herein may be performed by a machine in accordance with some embodiments. For example, method 600 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 600 may be represented by executable instructions that, when executed by a processor of a computing device, cause the computing device to perform method 600. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

At operation 602, the processor receives, from a user interface, a selection of an answer from the plurality of answers.

At operation 604, the processor determines further context and updates the context of the media asset based on the selection of the answer.

At operation 606, the processor uses one or more machine learning models to dynamically update the plurality of answers to include one or more additional answers (e.g., additional selectable answer choices) based on an analysis of the updated context of the media asset.

At operation 608, the processor causes the display of the updated plurality of answers in the user interface of the device.

Though not illustrated, method 600 can include an operation where a graphical user interface can be displayed (or caused to be displayed) by the hardware processor. For instance, the operation can cause a client device (e.g., the client device 102 communicatively coupled to the data management system 122) to display the graphical user interface for generating and managing one or more user response collection interfaces. This operation for displaying the graphical user interface can be separate from operations 602 through 608 or, alternatively, form part of one or more of operations 602 through 608.

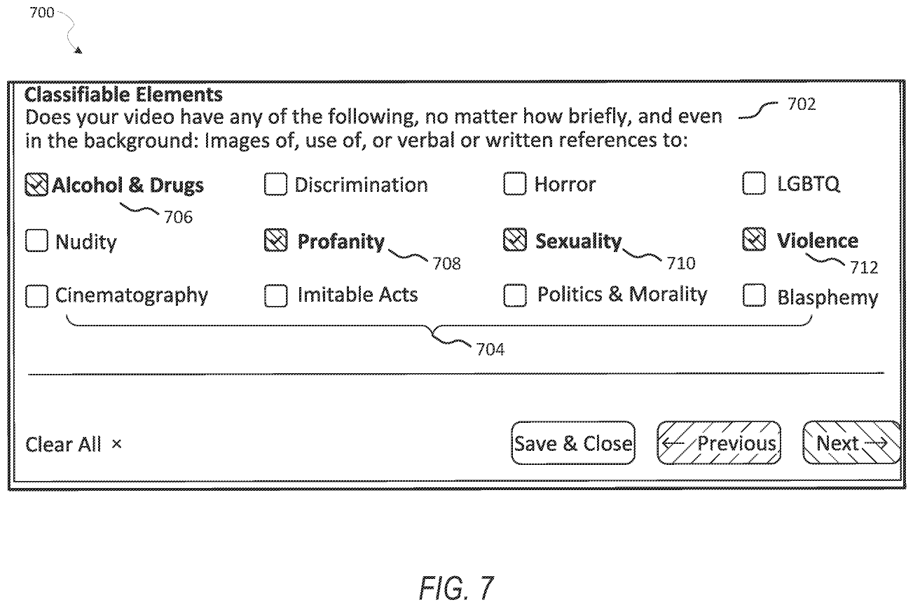

FIG. 7 illustrates an example graphical user interface 700 caused to be displayed by an example data management system during operation, according to various embodiments of the present disclosure. As shown, the graphical user interface 700 displays a user response collection interface (or a portion thereof) that includes question 702 and a plurality of answers 704. The plurality of answers 704 may be presented with answer choices 706, 708, 710, and 712 that are pre-selected. The pre-selection of answer choices is determined based on the learned context and/or content of the associated media asset.

In various embodiments, the plurality of answers 704 is presented without a pre-selection of recommended answers. Upon detecting that a user selected answer choice 706, the data management system (e.g., systems 122, 200) can use one or more machine learning models, as described herein, to auto-select answer choices 708, 710, and/or 712 based on the learned context and/or content of the associated media asset. In various embodiments, the data management system can update the context based on the selection of answer choice 706 and auto-select answer choices 708, 710, and/or 712 based on the analysis of the updated context using one or more machine learning models, as described herein.

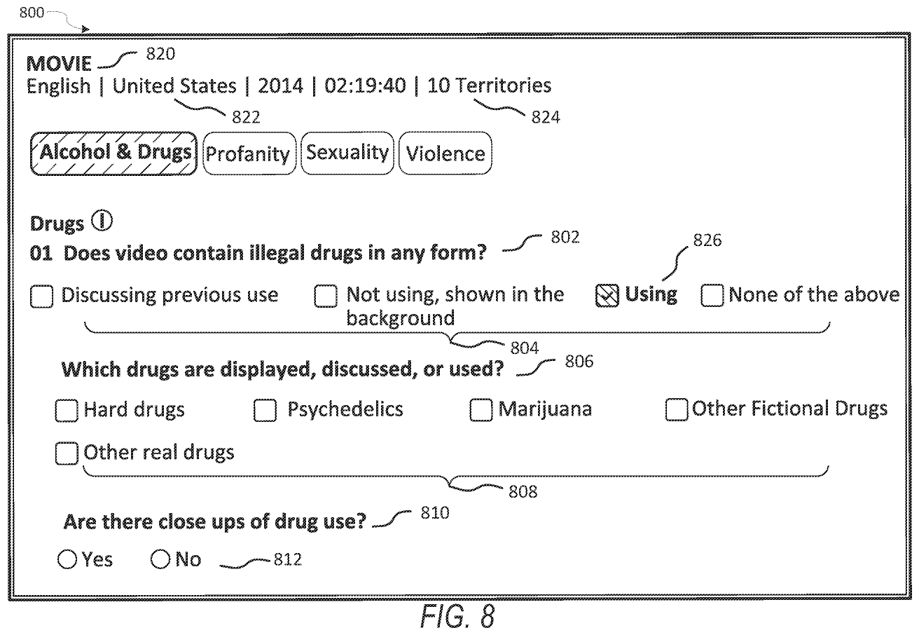

FIG. 8 illustrates an example graphical user interface 800 caused to be displayed by an example data management system during operation, according to various embodiments of the present disclosure. As shown, the graphical user interface 800 displays a user response collection interface (or a portion thereof) that includes a name (e.g., MOVIE) of a media asset 820, a geographical location 822 associated with the media asset (e.g., United States), and distribution regions 824 of the media asset (e.g., 10 territories). During operation, the graphical user interface 900 displays a user response collection interface (or a portion thereof) that may only include question 802 and a plurality of answers 804. Upon detecting a user selection of the answer choice 826, the data management system (e.g., systems 122, 200) can use one or more machine learning models, as described herein, to dynamically generate additional two questions (e.g., questions 806 and 810) and the associated plurality of answers (e.g., e.g., answers 808 and 812) based on the analysis of context (and/or content), geographical location 822, and/or taxonomy associated with the media asset 820.

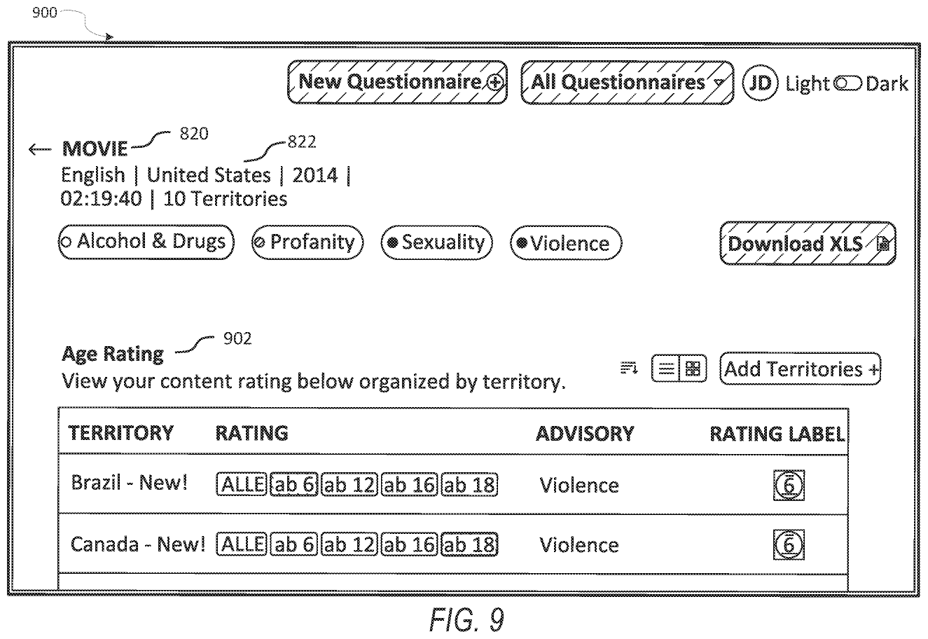

FIG. 9 illustrates an example graphical user interface 900 caused to be displayed by an example data management system during operation, according to various embodiments of the present disclosure. As shown, the graphical user interface 900 includes a list of age ratings 902 that is determined for the media asset 820. An age rating can be determined based on the analysis of the context and/or content of the media asset 820 using one or more machine learning models described herein. The analysis of the context and/or content of the media asset can be performed based on various factors. Example factors include answers to questions that are generated in a given user response collection interface, one or more taxonomies associated with the geographical location 822 (e.g., United States) of the media asset, and/or one or more distribution regions (e.g., 10 territories) associated with the media asset 820. A list of the ten distribution regions is not shown.

In various embodiments, the list of age ratings 902 can be provided (with costs or free of charge) upon finishing a user response collection interface that is provided (or configured) for media asset 820.

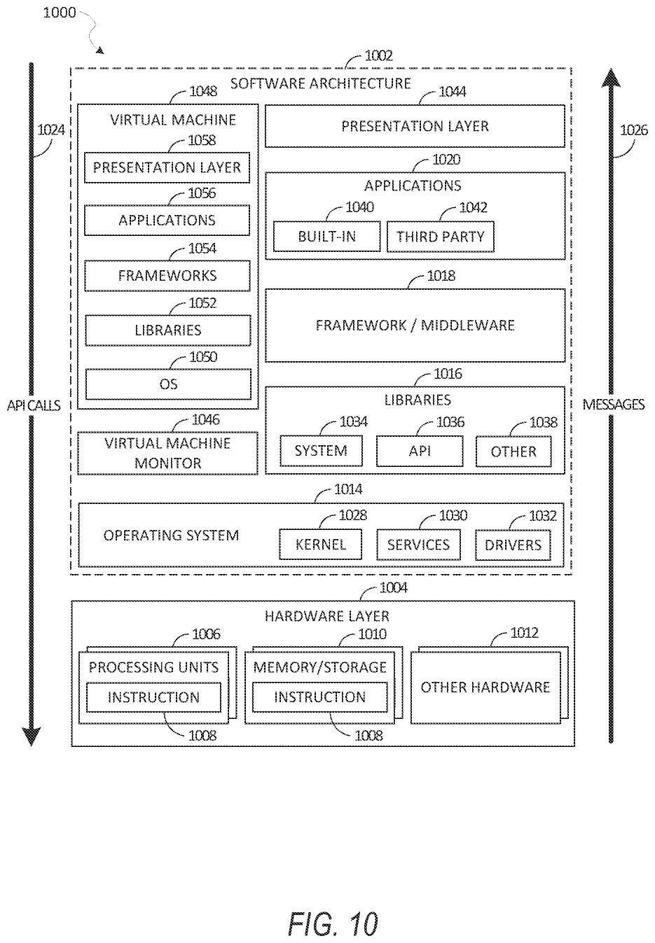

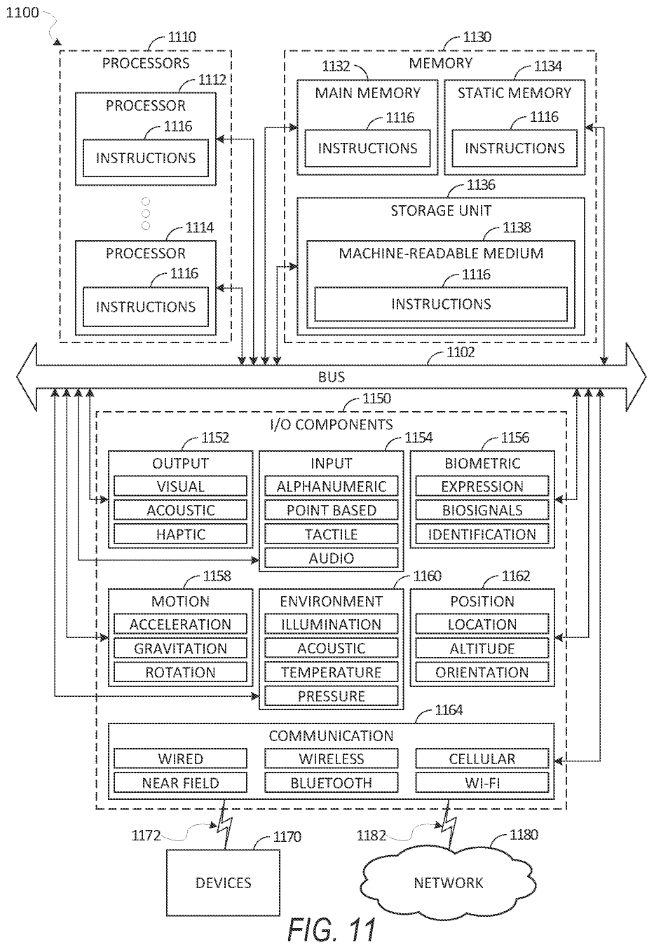

FIG. 10 is a block diagram 1000 illustrating an example of a software architecture 1002 that may be installed on a machine, according to some example embodiments. FIG. 10 is merely a non-limiting example of a software architecture, and it will be appreciated that many other architectures may be implemented to facilitate the functionality described herein. The software architecture 1002 may be executing on hardware such as a machine 1100 of FIG. 11 that includes, among other things, processors 1110, memory 1130, and input/output (I/O) components 1150. A representative hardware layer 1004 is illustrated and can represent, for example, the machine 1100 of FIG. 11. The representative hardware layer 1004 comprises one or more processing units 1006 having associated executable instructions 1008. The executable instructions 1008 represent the executable instructions of the software architecture 1002. The hardware layer 1004 also includes memory or storage modules 1010, which also have the executable instructions 1008. The hardware layer 1004 may also comprise other hardware 1012, which represents any other hardware of the hardware layer 1004, such as the other hardware illustrated as part of the machine 1100.

In the example architecture of FIG. 10, the software architecture 1002 may be conceptualized as a stack of layers, where each layer provides particular functionality. For example, the software architecture 1002 may include layers such as an operating system 1014, libraries 1016, frameworks/middleware 1018, applications 1020, and a presentation layer 1044. Operationally, the applications 1020 or other components within the layers may invoke API calls 1024 through the software stack and receive a response, returned values, and so forth (illustrated as messages 1026) in response to the API calls 1024. The layers illustrated are representative in nature, and not all software architectures have all layers. For example, some mobile or special-purpose operating systems may not provide a frameworks/middleware 1018 layer, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than by interfacing directly with the underlying operating system 1014 functionality (e.g., kernel 1028, services 1030, or drivers 1032). The libraries 1016 may include system libraries 1034 (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks 1018 (also sometimes referred to as middleware) may provide a higher-level common infrastructure that may be utilized by the applications 1020 or other software components/modules. For example, the frameworks 1018 may provide various graphical user interface functions, high-level resource management, high-level location services, and so forth. The frameworks 1018 may provide a broad spectrum of other APIs that may be utilized by the applications 1020 and/or other software components/modules, some of which may be specific to a particular operating system or platform.

The applications 1020 include built-in applications 1040 and/or third-party applications 1042. Examples of representative built-in applications 1040 may include, but are not limited to, a home application, a contacts application, a browser application, a book reader application, a location application, a media application, a messaging application, or a game application.

The third-party applications 1042 may include any of the built-in applications 1040, as well as a broad assortment of other applications. In a specific example, the third-party applications 1042 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 1042 may invoke the API calls 1024 provided by the mobile operating system such as the operating system 1014 to facilitate functionality described herein.

The applications 1020 may utilize built-in operating system functions (e.g., kernel 1028, services 1030, or drivers 1032), libraries (e.g., system libraries 1034, API libraries 1036, and other libraries 1038), or frameworks/middleware 1018 to create user interfaces to interact with users of the system. Alternatively, or additionally, in some systems, interactions with a user may occur through a presentation layer, such as the presentation layer 1044. In these systems, the application/module “logic” can be separated from the aspects of the application/module that interact with the user.

Some software architectures utilize virtual machines. In the example of FIG. 10, this is illustrated by a virtual machine 1048. The virtual machine 1048 creates a software environment where applications/modules can execute as if they were executing on a hardware machine (e.g., the machine 1100 of FIG. 11). The virtual machine 1048 is hosted by a host operating system (e.g., the operating system 1014) and typically, although not always, has a virtual machine monitor 1046, which manages the operation of the virtual machine 1048 as well as the interface with the host operating system (e.g., the operating system 1014). A software architecture executes within the virtual machine 1048, such as an operating system 1050, libraries 1052, frameworks/middleware 1054, applications 1056, or a presentation layer 1058. These layers of software architecture executing within the virtual machine 1048 can be the same as corresponding layers previously described or may be different.

FIG. 11 illustrates a diagrammatic representation of a machine 1100 in the form of a computer system within which a set of instructions may be executed for causing the machine 1100 to perform any one or more of the methodologies discussed herein, according to an embodiment. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. For example, the instructions 1116 may cause the machine 1100 to execute the method 400 described above with respect to FIG. 4. The instructions 1116 transform the general, non-programmed machine 1100 into a particular machine 1100 programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1110, memory 1130, and I/O components 1150, which may be configured to communicate with each other such as via a bus 1102. In an embodiment, the processors 1110 (e.g., a hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1112 and a processor 1114 that may execute the instructions 1116. The term “processor” is intended to include multi-core processors that may comprise two or more independent processors (sometimes referred to as “cores”) that may execute instructions contemporaneously. Although FIG. 11 shows multiple processors 1110, the machine 1100 may include a single processor with a single core, a single processor with multiple cores (e.g., a multi-core processor), multiple processors with a single core, multiple processors with multiples cores, or any combination thereof.

The memory 1130 may include a main memory 1132, a static memory 1134, and a storage unit 1136 including machine-readable medium 1138, each accessible to the processors 1110 such as via the bus 1102. The main memory 1132, the static memory 1134, and the storage unit 1136 store the instructions 1116 embodying any one or more of the methodologies or functions described herein. The instructions 1116 may also reside, completely or partially, within the main memory 1132, within the static memory 1134, within the storage unit 1136, within at least one of the processors 1110 (e.g., within the processor's cache memory), or any suitable combination thereof, during execution thereof by the machine 1100.

The I/O components 1150 may include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion, and the grouping is in no way limiting. In various embodiments, the I/O components 1150 may include output components 1152 and input components 1154. The output components 1152 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/O components 1150 may include biometric components 1156, motion components 1158, environmental components 1160, or position components 1162, among a wide array of other components. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1162 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via a coupling 1182 and a coupling 1172, respectively. For example, the communication components 1164 may include a network interface component or another suitable device to interface with the network 1180. In further examples, the communication components 1164 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a USB).

Moreover, the communication components 1164 may detect identifiers or include components operable to detect identifiers. For example, the communication components 1164 may include radio frequency identification (RFLD) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1164, such as location via Internet Protocol (IP) geolocation, location via Wi-Fi® signal triangulation, location via detecting an NFC beacon signal that may indicate a particular location, and so forth.

Certain embodiments are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In various embodiments, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 1100 including processors 1110), with these operations being accessible via a network (e.g., the Internet) and via one or more appropriate interfaces (e.g., an API). In certain embodiments, for example, a client device may relay or operate in communication with cloud computing systems, and may access circuit design information in a cloud environment.

The performance of certain of the operations may be distributed among the processors, not only residing within a single machine 1100, but deployed across a number of machines 1100. In some example embodiments, the processors 1110 or processor-implemented modules are located in a single geographic location (e.g., within a home environment, an office environment, or a server farm). In other example embodiments, the processors or processor-implemented modules are distributed across a number of geographic locations.

### Executable Instructions and Machine Storage Medium

The various memories (i.e., 1130, 1132, 1134, and/or the memory of the processor(s) 1110) and/or the storage unit 1136 may store one or more sets of instructions 1116 and data structures (e.g., software) embodying or utilized by any one or more of the methodologies or functions described herein. These instructions (e.g., the instructions 1116), when executed by the processor(s) 1110, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 1116 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various embodiments, one or more portions of the network 1180 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1180 or a portion of the network 1180 may include a wireless or cellular network, and the coupling 1182 may be a Code Division Multiple Access (CDMA) connection, a Global System for Mobile communications (GSM) connection, or another type of cellular or wireless coupling. In this example, the coupling 1182 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 1170. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A system comprising:
a memory storing instructions; and
one or more hardware processors communicatively coupled to the memory and configured by the instructions to perform operations comprising:
receiving a user input from a user interface of a device, the user input including data content that describes context of a media asset;
using a machine learning model to generate analysis of the context of the media asset based on the data content;
dynamically generating a question based on the analysis of the context of the media asset, the question being associated with a plurality of answers that are selectable for the question; and
causing display of the question and the plurality of answers on the user interface of the device.

2. The system of claim 1, wherein the operations further comprise:
dynamically selecting one or more recommended answers from the plurality of answers based on the analysis of the context of the media asset.

3. The system of claim 2, wherein the dynamically selecting of the one or more recommended answers from the plurality of answers based on the analysis of the context of the media asset comprises:
determining a geographical location associated with the media asset based on the data content;
determining a taxonomy associated with the geographical location; and
using a machine learning model to dynamically select the one or more recommended answers based on the taxonomy and the context of the media asset.

4. The system of claim 1, wherein the machine learning model is built and trained based on prompt engineering technology.

5. The system of claim 1, wherein the using of the machine learning model to generate the analysis of the context of the media asset based on the data content further comprises:
generating a task description based on the context of the media asset;
identifying an example question and a set of example answers based on the task description and a taxonomy associated with a geographical location of the media asset;
generating a prompt input that includes the task description, the example question, and the set of example answers; and
using the machine learning model to dynamically generate the question and the plurality of answers based on the prompt input.

6. The system of claim 5, wherein the machine learning model is a Natural language processing (NLP) machine learning model.

7. The system of claim 5, wherein the example question is a first example question, and wherein the set of example answers is a first set of example answers, wherein the operations further comprise:
receiving, from the user interface, a selection of an answer from the plurality of answers;
updating the context of the media asset based on the selection of the answer;
generating a second task description based on the updated context of the media asset;
identifying a second example question and a second set of example answers based on the second task description and the taxonomy associated with the geographical location of the media asset;
generating a second prompt input that includes the second task description, the second example question, and the second set of example answers;
using the machine learning model to dynamically generate a second question and a second plurality of answers based on the second prompt input; and
causing display of the second question and the second plurality of answers in the user interface of the device.

8. The system of claim 1, wherein the context of the media asset is first context, the question is a first question, and the plurality of answers is a first plurality of answers, wherein the operations further comprise:
receiving, from the user interface, a selection of an answer from the plurality of answers;
determining second context of the media asset based on the selection of the answer; and
dynamically generating a second question based on an analysis of the second context of the media asset, the second question being associated with a second plurality of answers.

9. The system of claim 1, wherein the operations further comprise:
receiving the media asset from the device;
generating the user interface that includes a user response collection interface; and
causing display of the user interface on the device for receiving the user input.

10. The system of claim 1, wherein the operations further comprise:
receiving, from the user interface, a selection of an answer from the plurality of answers;
updating the context of the media asset based on the selection of the answer;
using a machine learning model to dynamically update the plurality of answers to include one or more additional answers based on an analysis of the updated context of the media asset; and
causing display of the updated plurality of answers in the user interface of the device.

11. The system of claim 1, wherein the operations further comprise:
receiving, from the user interface, a selection of an answer from the plurality of answers;
updating the context of the media asset based on the selection of the answer;
dynamically selecting one or more recommended answers from the plurality of answers based on an analysis of the updated context of the media asset; and
causing display of the one or more recommended answers in the user interface of the device.

12. The system of claim 1, wherein the operations further comprise:
receiving, from the user interface, a selection of an answer from the plurality of answers;
updating the context of the media asset based on the selection of the answer; and
generating one or more questions and selecting one or more recommended answers to each of the one or more questions based on an analysis of the updated context of the media asset.

13. A method comprising:
receiving a user input from a user interface of a device, the user input including data content that describes context of a media asset;
using a machine learning model to generate analysis of the context of the media asset based on the data content;
dynamically generating a question based on the analysis of the context of the media asset, the question being associated with a plurality of answers that are selectable for the question; and
causing display of the question and the plurality of answers on the user interface of the device.

14. The method of claim 13, further comprising:
dynamically selecting one or more recommended answers from the plurality of answers based on the analysis of the context of the media asset.

15. The method of claim 14, wherein the dynamically selecting of the one or more recommended answers from the plurality of answers based on the analysis of the context of the media asset comprises:
determining a geographical location associated with the media asset based on the data content;
determining a taxonomy associated with the geographical location; and
using a machine learning model to dynamically select the one or more recommended answers based on the taxonomy and the context of the media asset.

16. The method of claim 13, wherein the machine learning model is built and trained based on prompt engineering technology.

17. The method of claim 13, wherein the using of the machine learning model to generate the analysis of the context of the media asset based on the data content further comprises:
generating a task description based on the context of the media asset;
identifying an example question and a set of example answers based on the task description and a taxonomy associated with a geographical location of the media asset;
generating a prompt input that includes the task description, the example question, and the set of example answers; and
using the machine learning model to dynamically generate the question and the plurality of answers based on the prompt input.

18. The method of claim 17, wherein the machine learning model is a Natural language processing (NLP) machine learning model.

19. The method of claim 17, wherein the example question is a first example question, and wherein the set of example answers is a first set of example answers, the method further comprising:
receiving, from the user interface, a selection of an answer from the plurality of answers;
updating the context of the media asset based on the selection of the answer;
generating a second task description based on the updated context of the media asset;
identifying a second example question and a second set of example answers based on the second task description and the taxonomy associated with the geographical location of the media asset;
generating a second prompt input that includes the second task description, the second example question, and the second set of example answers;
using the machine learning model to dynamically generate a second question and a second plurality of answers based on the second prompt input; and
causing display of the second question and the second plurality of answers in the user interface of the device.

20. A non-transitory computer-readable medium comprising instructions that, when executed by a hardware processor of a device, cause the device to perform operations comprising:
receiving a user input from a user interface of the device, the user input including data content that describes context of a media asset;
using a machine learning model to generate analysis of the context of the media asset based on the data content;
dynamically generating a question based on the analysis of the context of the media asset, the question being associated with a plurality of answers that are selectable for the question; and
causing display of the question and the plurality of answers on the user interface of the device.
